(19) United States
(12) Patent Application Publication
(10) Pub. No.: US 2018/0336696 A1
(43) Pub. Date: Nov. 22, 2018

(54) DISPLAY CONTROL PROGRAM, DISPLAY CONTROL APPARATUS AND DISPLAY CONTROL METHOD

(71) Applicant: FUJITSU LIMITED, Kawasaki-shi (JP)

(72) Inventor: Shuji Matsumoto, Kawasaki (JP)

(21) Appl. No.: 15/978,411

(22) Filed: May 14, 2018

(30) Foreign Application Priority Data
May 22, 2017 (JP) 2017-100919

(51) Int. Cl. G06T 7/70; G06T 19/00; G02B 27/01

(52) U.S. Cl. CPC G06T 7/70; G06T 19/006; G02B 2027/0178; G02B 2027/014; G02B 2027/0138; G02B 27/0172

(57) ABSTRACT

A display control method includes: acquiring an image captured by an image capture apparatus; specifying a position and a direction of the image capture apparatus by a sensor; acquiring display information being associated with position information in an area according to the specified position and direction of the image capture apparatus; acquiring distance information, from among objects included in the image, to an object positioned at a display position according to the position information associated with the acquired display information; deciding whether or not the acquired display information is to be displayed on a display apparatus based on the acquired distance information and position information associated with the acquired display information; and displaying, in the case where it is decided that the display information is to be displayed, an image including a content based on the display information and the image on the display apparatus.

### CROSS-REFERENCE TO RELATED APPLICATION

This application is based upon and claims the benefit of priority of the prior Japanese Patent Application No. 2017-100919, filed on May 22, 2017, the entire contents of which are incorporated herein by reference.

### FIELD

The embodiments discussed herein are related to a display control program, a display control apparatus and a display control method.

### BACKGROUND

An AR (Augmented Reality) technology is available by which display information stored in an associated relationship with position information in an area specified in accordance with a position and a direction of a portable terminal is displayed on a captured image picked up by the portable terminal.

In the AR technology, when a user picks up an image by directing a portable terminal to a given direction, display information (hereinafter referred to as AR content) corresponding to the position information may be automatically displayed on the captured image. Therefore, the user may view, at various places, an AR content according to each place through the portable terminal.

Examples of the related art include Japanese Laid-open Patent Publication No. 2015-138445.

### SUMMARY

According to an aspect of the invention, a display control method, performed by a computer, includes: executing first processing that includes acquiring an image captured by an image capture apparatus; executing second processing that includes specifying a position and a direction of the image capture apparatus by a sensor; executing third processing that includes acquiring, from a storage unit configured to store a plurality of display information each of which is associated with position information, display information and position information associated with the display information, the display information being associated with position information in an area according to the specified position and direction of the image capture apparatus; executing fourth processing that includes acquiring distance information, from among objects included in the image, to an object positioned at a display position according to the position information associated with the acquired display information; executing fifth processing that includes deciding whether or not the acquired display information is to be displayed on a display apparatus based on the acquired distance information and position information associated with the acquired display information; and executing sixth processing that includes displaying, in the case where it is decided that the display information is to be displayed, an image including a content based on the display information and the image on the display apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram depicting an example of an entire configuration of an AR content displaying system;

FIG. 2 is a first view depicting an example of display of a captured image picked up by a portable terminal and an AR content;

FIG. 3 is a block diagram depicting an example of a hardware configuration of a portable terminal;

FIG. 4 is a block diagram depicting an example of a functional configuration of a display controlling unit;

FIG. 5 is a view illustrating an example of AR content management information;

FIGS. 6A and 6B are views illustrating a positional relationship between an AR content and an object and an editing method of the AR content based on the positional relationship;

FIG. 7 is a first flow chart of a display controlling process;

FIG. 8 is a second view depicting an example of display of a captured image picked up by a portable terminal and an AR content;

FIG. 9 is a view illustrating a positional relationship of a plurality of AR contents;

FIG. 10 is a second flow chart of the display controlling process;

FIG. 11 is a third view depicting an example of display of a captured image picked up by a portable terminal and an AR content;

FIG. 12 is a view depicting an example of an object distance acquisition range by an object distance acquisition unit; and

FIG. 13 is a view depicting an example of an object distance calculation process by the object distance acquisition unit.

### DESCRIPTION OF EMBODIMENTS

According to the conventional AR technology, when an AR content is to be displayed, the sense of distance from a position of image capture device to a point at which the AR content is positioned is not taken into consideration. Therefore, for example, although an object included in a captured image is positioned on the near side with respect to an AR content, the AR content may possibly be displayed on the near side. Further, although the AR content is positioned farther, it may possibly be displayed large. Such phenomena give rise to a problem that the user is less likely to grasp the position of the AR content on the captured image.

According to an aspect of the present disclosure, provided are technologies for making it possible to grasp a position of display information regarding a captured image.

In the following, embodiments are described with reference to the accompanying drawings. It is to be noted that, in the specification and the drawings, components having substantially same functional configurations are denoted by same reference symbols and overlapping description of them is omitted herein.

### First Embodiment

<AR Content Displaying System>

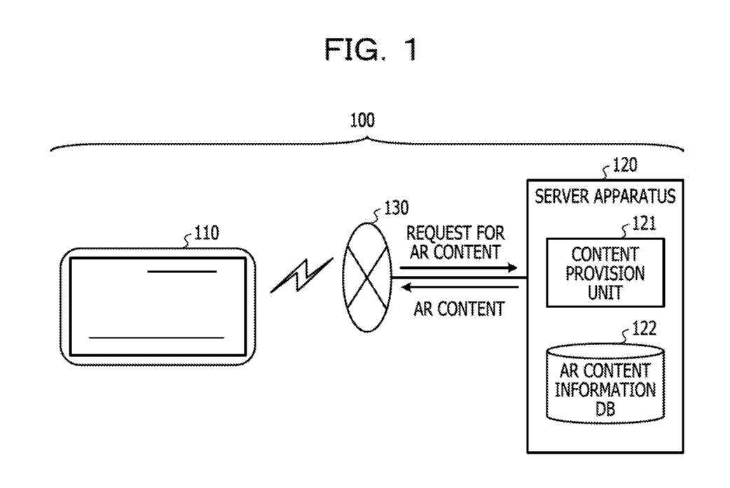

First, an AR content displaying system including a portable terminal that displays an AR content that is an example of display information and a server apparatus that provides an AR content to the portable terminal will be described. FIG. 1 is a block diagram depicting an example of an entire configuration of an AR content displaying system.

As depicted in FIG. 1, an AR content displaying system 100 includes a portable terminal 110 and a server apparatus 120, which are coupled to each other through a network 130.

The portable terminal 110 is an example of a display controlling apparatus. In the first embodiment, a display controlling program is installed in the portable terminal 110. The portable terminal 110 specifies, for example, a position and a direction of an image capture unit of the portable terminal 110 by executing the display controlling program. Further, the portable terminal 110 requests the server apparatus 120 for an AR content stored in the server apparatus 120 in an associated relationship with position information in an area specified in response to the position and the direction of the image capture unit.

Further, the portable terminal 110 stores an AR content transmitted from the server apparatus 120 by executing the display controlling program. Then, the portable terminal 110 generates an image in which the AR content is disposed at a corresponding display position on a captured image of a real world picked up by the image capture unit and displays the image on a display screen.

The server apparatus 120 is an apparatus that transmits an AR content to the portable terminal 110 in response to a request from the portable terminal 110. A content provision program is installed in the server apparatus 120 such that, as the program is executed, the server apparatus 120 functions as a content provision unit 121.

The content provision unit 121 receives an AR content request from the portable terminal 110 through the network 130. The AR content request includes information relating to an area specified in accordance with the position and the direction of the image capture unit of the portable terminal 110. The content provision unit 121 refers to an AR content information database (DB) 122 based on the information regarding the area included in the AR content request. Consequently, the content provision unit 121 acquires an AR content stored in an associated relationship with the position information in the area from among a plurality of AR contents stored in an associated relationship with each piece of position information (position information in the world coordinate system such as latitude, longitude, and height). Then, the content provision unit 121 transmits the acquired AR content and the position information stored in an associated with the AR content to the portable terminal 110 that is a request source of the AR content request.

<Example of Display of AR Content>

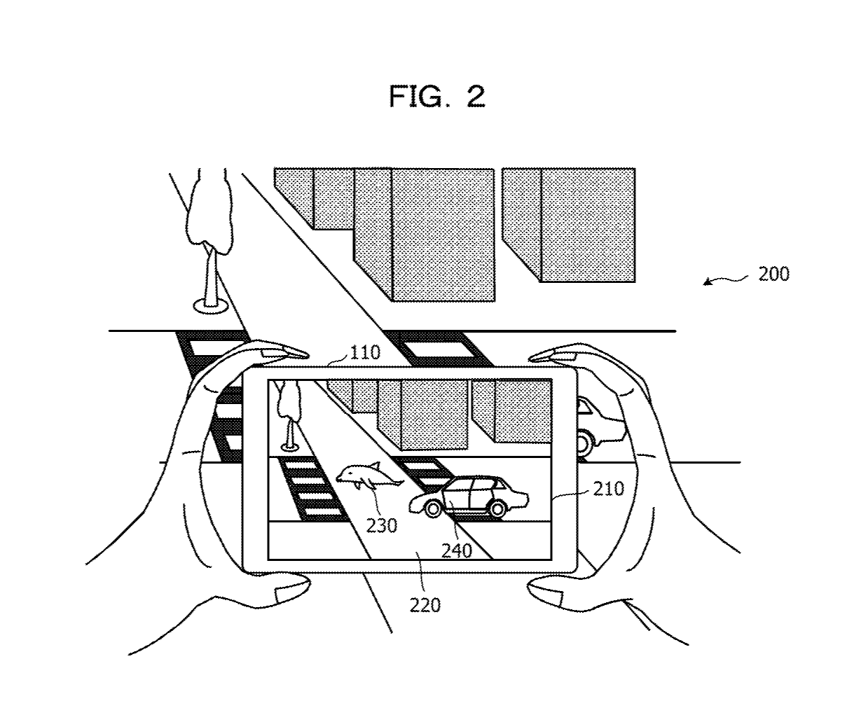

Now, an example of display of a display screen of the portable terminal 110 that displays, at a display position corresponding to the captured image, an image at which an AR content is disposed. FIG. 2 is a first view depicting an example of display of a captured image picked up by a portable terminal and an AR content.

As depicted in FIG. 2, an image 220 displayed on a display screen 210 of the portable terminal 110 includes a captured image of a real world 200 (for example, a captured image in which an object 240 is included). Further, the image 220 includes an AR content 230. It is to be noted that the AR content 230 is disposed at the display position on the captured image corresponding to the position information (latitude, longitude, and height) associated with the AR content 230.

<Hardware Configuration of Portable Terminal>

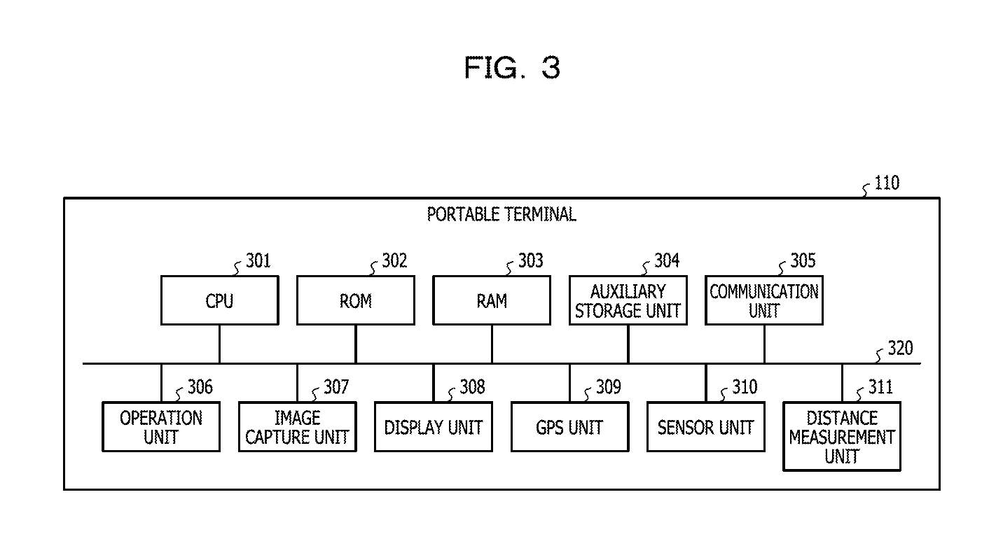

Now, a hardware configuration of the portable terminal 110 is described. FIG. 3 is a block diagram depicting an example of a hardware configuration of a portable terminal.

As depicted in FIG. 3, the portable terminal 110 includes a central processing unit (CPU) 301, a read only memory (ROM) 302 and a random access memory (RAM) 303. The CPU 301, ROM 302 and RAM 303 form a so-called computer. Further, the portable terminal 110 includes an auxiliary storage unit 304, a communication unit 305, an operation unit 306, an image capture unit 307, a display unit 308, a global positioning system (GPS) unit 309, a sensor unit 310 and a distance measurement unit 311. It is to be noted that the components of the portable terminal 110 are coupled to each other through a bus 320.

The CPU 301 executes various programs (for example, a display controlling program) installed in the auxiliary storage unit 304.

The ROM 302 is a nonvolatile memory. The ROM 302 functions as a main storage device that stores various programs, data and so forth needed to allow the CPU 301 to execute the various programs installed in the auxiliary storage unit 304. The ROM 302 stores a boot program such as a basic input/output system (BIOS) or an extensible firmware interface (EFI).

The RAM 303 is a volatile memory such as a dynamic random access memory (DRAM) or a static random access memory (SRAM). The RAM 303 functions as a main storage device that provides a working area in which the various programs installed in the auxiliary storage unit 304 are to be deployed when the programs are to be executed by the CPU 301.

The auxiliary storage unit 304 is an auxiliary storage device that stores the various programs installed in the portable terminal 110, data to be used when the various programs are executed, and so forth. An AR content management database (hereinafter referred to simply as DB) hereinafter described is implemented in the auxiliary storage unit 304.

The communication unit 305 is a communication device for allowing the portable terminal 110 to communicate with the server apparatus 120 through the network 130. The operation unit 306 is an operation device for allowing a user to input various instructions to the portable terminal 110.

The image capture unit 307 is, for example, an image pickup device that picks up an image of a real world to generate a captured image. The display unit 308 includes the display screen 210 depicted in FIG. 2 and displays an image 220 and so forth.

The GPS unit 309 communicates with a GPS to detect the position (latitude, longitude, and height) of the image capture unit 307 of the portable terminal 110.

The sensor unit 310 includes a geomagnetic sensor that detects geomagnetism and an acceleration sensor that detects an acceleration. The sensor unit 310 detects the direction of the image capture unit 307 of the portable terminal 110 based on results of detection of the geomagnetic sensor and the acceleration sensor.

The distance measurement unit 311 measures the distance to each object by one of methods that use ultrasonic waves, infrared rays, a laser beam or the like. Alternatively, the distance measurement unit 311 may be a monocular camera that may measure the distance. The monocular camera that may measure the distance is a camera in which a given color aperture filter is attached to a lens aperture and blur and color drift according to the distance to each object are analyzed by image analysis to calculate distance information indicative of the distance to each object for each pixel.

<Functional Configuration of Display Controlling Unit>

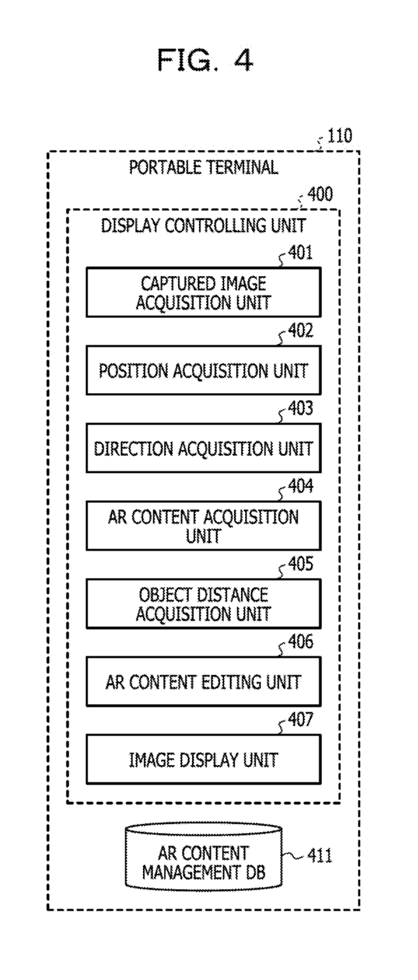

Now, a functional configuration of the display controlling unit implemented by execution of the display controlling program by the portable terminal 110 is described. FIG. 4 is a block diagram depicting an example of a functional configuration of a display controlling unit. As depicted in FIG. 4, the display controlling unit 400 includes a captured image acquisition unit 401 that is an example of a first acquisition unit, and a position acquisition unit 402 and a direction acquisition unit 403 that are an example of a specification unit. Further, the display controlling unit 400 includes an AR content acquisition unit 404 that is an example of a second acquisition unit, an object distance acquisition unit 405 that is an example of a third acquisition unit, an AR content editing unit 406 that is an example of a decision unit, and an image displaying unit 407 that is an example of a control unit.

The captured image acquisition unit 401 acquires a captured image generated by the image capture unit 307 picking up an image of a real world and notifies the image displaying unit 407 of the captured image.

The position acquisition unit 402 specifies the position (latitude, longitude, and height) of the image capture unit 307 of the portable terminal 110 based on the position detected by the GPS unit 309 and notifies the AR content acquisition unit 404 of the position information.

The direction acquisition unit 403 specifies the direction of the image capture unit 307 of the portable terminal 110 based on the direction detected by the sensor unit 310 and notifies the AR content acquisition unit 404 of the direction information.

The AR content acquisition unit 404 specifies an area according to the position information and the direction information of the image capture unit 307 notified of from the position acquisition unit 402 and the direction acquisition unit 403, respectively. Further, the AR content acquisition unit 404 transmits an AR content request including information relating to the specified area to the server apparatus 120. Further, the AR content acquisition unit 404 acquires an AR content and position information associated with the AR content both received from the server apparatus 120 in response to the transmission of the AR content request. Furthermore, the AR content acquisition unit 404 stores the acquired AR content and position information associated with the AR content into an AR content management DB 411.

Further, the AR content acquisition unit 404 notifies the object distance acquisition unit 405 of the information relating to the specified area and refers to the AR content management DB 411 to select the AR content stored in an associated relationship with the position information in the specified area. Further, the AR content acquisition unit 404 reads out the selected AR content and the position information stored in an associated relationship with the AR content from the AR content management DB 411 and notifies the AR content editing unit 406 of the AR content and the position information.

The object distance acquisition unit 405 acquires distance information indicative of the distance to each object included in the area from the distance measurement unit 311. Further, the object distance acquisition unit 405 notifies the AR content editing unit 406 of the acquired distance information to each object.

The AR content editing unit 406 calculates the distance from the image capture unit 307 of the portable terminal 110 to the AR content based on the position information stored in an associated relationship with the AR content. Further, the AR content editing unit 406 compares the calculated distance information to the AR content and the distance information of the objects notified of from the object distance acquisition unit 405 with each other to decide the positional relationship between them.

Further, the AR content editing unit 406 decides whether or not some object is positioned on the near side with respect to the AR content as viewed from the image capture unit 307 as a result of the comparison thereby to decide whether or not the AR content is to be displayed in the display screen image. In a case where the AR content editing unit 406 decides that some object is positioned on the near side with respect to the AR content, it decides that the entirety or part of the AR content is not to be displayed on the display screen 210. In this case, the AR content editing unit 406 edits the AR content based on the object and notifies the image displaying unit 407 of the edited AR content.

For example, the AR content editing unit 406 specifies a region to be hidden by the object (overlapping behind the object) because the object is positioned on the near side with respect to the AR content. The AR content editing unit 406 performs editing for deleting the specified region and notifies the image displaying unit 407 of the edited AR content.

The image displaying unit 407 generates an image to be displayed on the display screen 210 of the display unit 308 based on the captured image notified of from the captured image acquisition unit 401 and the edited AR content notified of from the AR content editing unit 406. The image displaying unit 407 transmits the generated image to the display unit 308.

<AR Content Management Information>

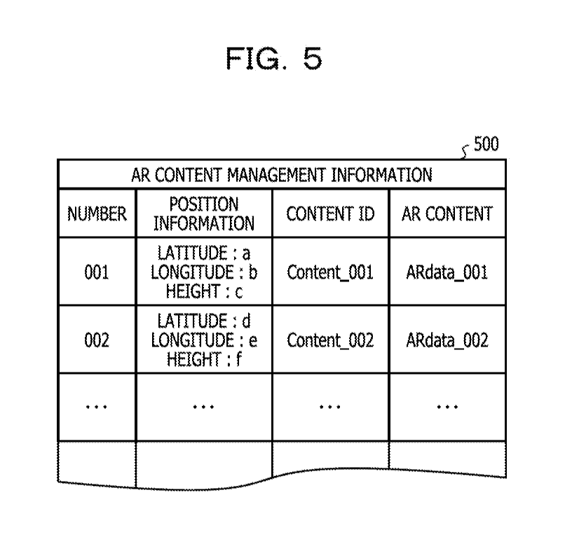

Now, the AR content management information stored in the AR content management DB 411 is described. FIG. 5 is a view illustrating an example of AR content management information. As depicted in FIG. 5, the AR content management information 500 includes, as items of information, a “number,” “position information,” a “content identifier (ID)” and an “AR content.”

In the “number,” a serial number applied when each AR content is stored into the AR content management DB 411 is stored. In the “position information,” position information (latitude, longitude, and height) acquired by the AR content acquisition unit 404 and associated with the AR content is stored.

In the “content ID,” an identifier for identifying the AR content is stored. In the “AR content,” main body data and attribute data (data size and so forth) of the AR content acquired by the AR content acquisition unit 404 are stored.

<Positional Relationship Between AR Content and Object and Editing Method for AR Content Based on Positional Relationship>

Now, a positional relationship between an AR content and an object in a case where viewed from the image capture unit 307 of the portable terminal 110 and an editing method for the AR content based on the positional relationship are described.

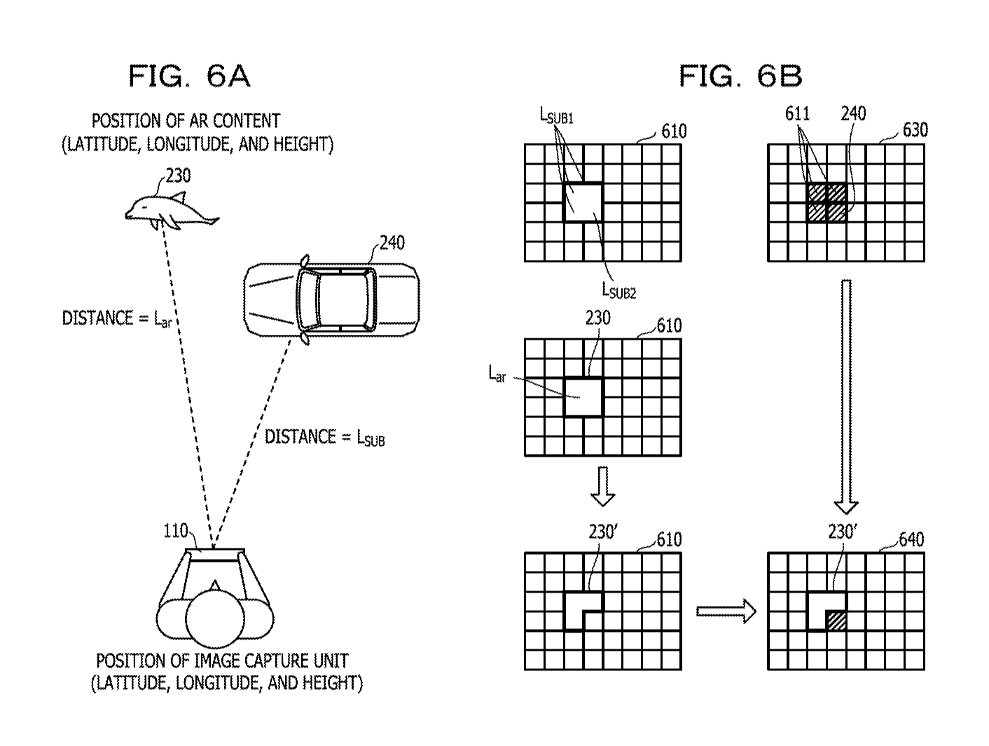

FIGS. 6A and 6B are views illustrating a positional relationship between an AR content and an object and an editing method for the AR content based on the positional relationship. As depicted in FIG. 6A, distance information indicative of the distance to the AR content 230 as viewed from the image capture unit 307 of the portable terminal 110 is calculated based on the position information (latitude, longitude, and height) associated with the AR content 230 and the position information (latitude, longitude, and height) of the image capture unit 307 of the portable terminal 110.

For example, it is assumed that the AR content acquisition unit 404 acquires the latitude=“a,” longitude=“b,” and height “c” as the position information associated with the AR content 230. Further, it is assumed that the position acquisition unit 402 acquires the latitude=“A,” longitude=“B,” and height=“C” as the position information indicative of the position of the image capture unit 307 of the portable terminal 110. In this case, the distance information x indicative of the distance on a spherical plane between the image capture unit 307 of the portable terminal 110 and the AR content 230 may be represented, by applying the cosine theorem, by the following expression:

cos x=cos(90−A)cos(90−a)+sin(90−A)sin(90−a)cos(b−B)

x=cos⁻¹(sin A sin a+cos A cosa cos(b−B)) (1)

If the radius of the earth is represented by R and the distance information x is converted into radian, the distance information L indicative of the distance on a spherical plane between the image capture unit 307 of the portable terminal 110 and the AR content 230 may be represented by the following expression:

L=R×n/180 (2)

Accordingly, the distance information Lar indicative of the distance to the AR content 230 as viewed from the image capture unit 307 of the portable terminal 110 is represented by the following expression:

Lar=\sqrt{L²+(C−c)²} (3)

On the other hand, the AR content editing unit 406 acquires distance information Lsub from the image capture unit 307 of the portable terminal 110 to the object 240 by receiving a notification from the object distance acquisition unit 405.

Consequently, the AR content editing unit 406 may compare the distance information Lar and the distance information Lsub with each other. As a result, the AR content editing unit 406 may decide the positional relationship regarding whether the object 240 is positioned on the near side or the AR content 230 is positioned on the near side as viewed from the image capture unit 307 of the portable terminal 110. For example, in the case where Lar>Lsub, the AR content editing unit 406 decides that the object 240 is positioned on the near side. In the case where Lar≤Lsub, the AR content editing unit 406 decides that the AR content 230 is positioned on the near side.

After the positional relationship between the AR content and the object is decided, the AR content editing unit 406 edits the AR content. FIG. 6B illustrates an example in which the editing method is simplified. It is assumed that, as depicted at the upper stage of FIG. 6B, distance information (Lsub1, Lsub2 and so forth) to objects 240 and 611 and so forth are acquired in an associated relationship with the positions of pixels of a captured image 630 within an object acquisition range 610 based on the area by the object distance acquisition unit 405. The objects 611 here are a road of the background. It is to be noted that the distance information to the objects 240 and 611 may be acquired by distance measurement by a method using ultrasonic waves, infrared rays, a laser beam or the like within the object acquisition range 610, or may be measured by a monocular camera that may perform distance measurement. In the case where a monocular camera that may perform distance measurement is used, the distance information to an object corresponding to each of pixels included in the captured image 630 may be associated readily.

Further, as depicted at an intermediate stage of FIG. 6B, the AR content editing unit 406 disposes the AR content 230 (Lsub1>Lar>Lsub2) with regard to which the distance information indicative of the distance from the image capture unit 307 of the portable terminal 110 is Lar at a corresponding position of the object acquisition range 610. Consequently, the AR content editing unit 406 may acquire the distance information to the object 240 that is positioned at the display position according to the position information associated with the AR content 230 (distance information associated with a pixel corresponding to the display position of the AR content). As a result, the AR content editing unit 406 may specify a region to be hidden by the object 240 from within the AR content 230.

Further, as depicted at a lower stage of FIG. 6B, the AR content editing unit 406 generates an edited AR content 230′ by performing editing for deleting the specified region. Then, the image displaying unit 407 disposes the edited AR content 230′ at the corresponding position on the captured image 630 to generate an image 640.

In this manner, the image displaying unit 407 may generate an image that includes an AR content edited based on the positional relationship between the AR content and the object.

<Flow of Display Controlling Process>

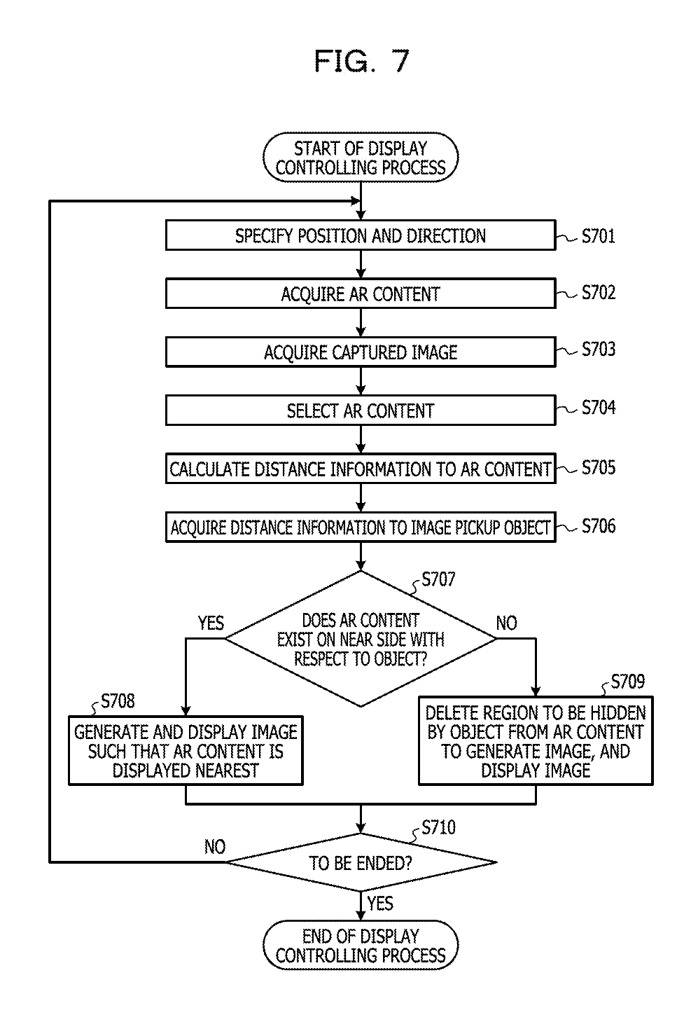

Now, a flow of the display controlling process by the display controlling unit 400 is described. FIG. 7 is a first flow chart of a display controlling process. The display controlling process depicted in FIG. 7 is started in response to activation of the display controlling unit 400.

At step S701, the position acquisition unit 402 specifies the position (latitude, longitude, and height) of the image capture unit 307 of the portable terminal 110 detected by the GPS unit 309. Further, the direction acquisition unit 403 specifies the direction of the image capture unit 307 of the portable terminal 110 detected by the sensor unit 310.

At step S702, the AR content acquisition unit 404 specifies an area according to the position and the direction of the image capture unit 307 of the portable terminal 110 and transmits an AR content request including information relating to the specified area to the server apparatus 120. Further, the AR content acquisition unit 404 acquires an AR content and position information associated with the AR content both transmitted from the server apparatus 120 and stores the AR content and the position information into the AR content management DB 411. Note that it is assumed that, when the AR content request is received, the server apparatus 120 transmits AR contents other than any AR content transmitted already and position information associated with the AR contents to the portable terminal 110.

At step S703, the captured image acquisition unit 401 acquires a captured image picked up by the image capture unit 307.

At step S704, the AR content acquisition unit 404 selects an AR content stored in an associated relationship with the specified position information in the area and reads out the selected AR content from the AR content management DB 411. Further, the AR content acquisition unit 404 reads out position information stored in an associated relationship with the read out AR content from the AR content management DB 411.

At step S705, the AR content editing unit 406 calculated distance information from the image capture unit 307 of the portable terminal 110 to the AR content based on the position information associated with the read out AR content.

At step S706, the object distance acquisition unit 405 acquires distance information to the objects included in the image pickup distance acquisition range based on the specified area from the distance measurement unit 311.

At step S707, the AR content editing unit 406 decides the positional relationship between the AR content and each object (whether or not the AR content is positioned on the near side with respect to each object). If it is decided at step S707 that the AR content is positioned on the near side with respect to the object (in the case of Yes at step S707), the processing advances to step S708.

At step S708, the image displaying unit 407 generates an image by disposing the AR content at a corresponding display position on the captured image such that the AR content is positioned nearest. Further, the image displaying unit 407 displays the generated image on the display unit 308.

On the other hand, if it is decided at step S707 that the AR content is not positioned on the near side with respect to the object (in the case of No at step S707), the processing advances to step S709.

At step S709, the AR content editing unit 406 performs editing for deleting a region that is to be hidden by any object positioned on the near side with respect to the AR content. Further, the image displaying unit 407 generates an image by disposing the AR content edited already at a corresponding display position on the captured image.

At step S710, the display controlling unit 400 decides whether or not the display controlling process is to be ended. If the function of the display controlling unit 400 is to be utilized continuously (in the case of No at step S710), the processing returns to step S701.

On the other hand, in the case where the function of the display controlling unit 400 is stopped (in the case of Yes at step S710), the display controlling process is ended.

<Example of Display of AR Content>

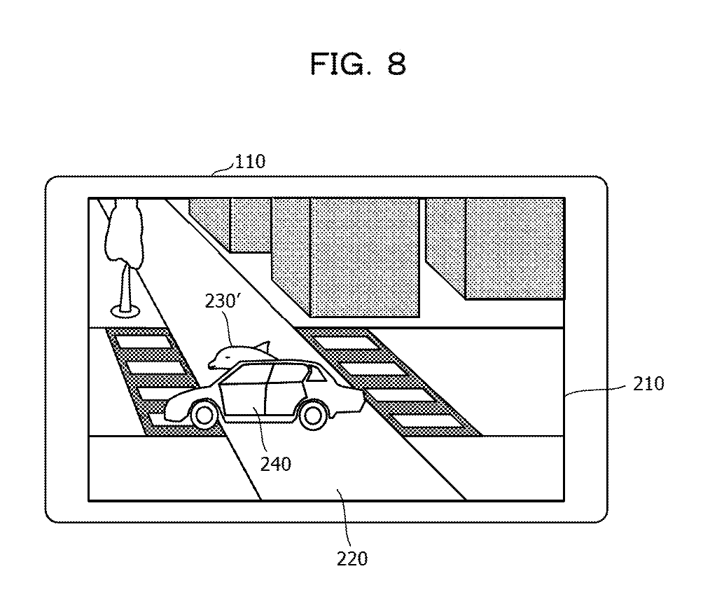

Now, an example of display of the edited AR content 230′ edited by the AR content editing unit 406 is described. FIG. 8 is a second view depicting an example of display of a captured image picked up by a portable terminal and an AR content. As depicted in FIG. 8, in the case of the edited AR content 230′, since the object 240 is positioned on the near side, a region hidden by the object 240 is not displayed on the display screen 210.

As apparent from the foregoing description, the portable terminal 110 according to the first embodiment specifies an area according to a position and a direction of the image capture unit and displays an AR content stored in an associated relationship with position information in the specified area at a corresponding display position on a captured image. Thereupon, the portable terminal 110 according to the first embodiment decides, based on distance information indicative of the distance to an AR content as viewed from the image capture unit and distance information to an object included in the captured image, the positional relationship between the AR content and the object, and edits the AR content based on the decided positional relationship.

By controlling the display of the AR content on the captured image in response to the distance information to the AR content in this manner, the portable terminal 110 may readily grasp the position of the AR content on the captured image according to the position information with which the AR content is associated. As a result, such a situation that, although the object whose image is picked up is positioned on the near side with respect to the AR content, the AR content is displayed on the near side may be suppressed, and the incompatibility of the display mode may be reduced.

### Second Embodiment

In the foregoing description of the first embodiment, a case is described in which, based on a positional relationship between an AR content and an object as viewed from the image capture unit, editing for deleting a region of the AR content to be hidden by the object is performed. In contrast, in the following description of a second embodiment, a case is described in which, based on distance information indicative of a distance to an AR content as viewed from the image capture unit, editing for changing the size of the AR content is described. It is to be noted that the following description is given principally in regard to differences from the first embodiment.

<Positional Relationship Between Plural AR Contents>

First, a positional relationship of a plurality of AR contents as viewed from the image capture unit 307 of the portable terminal 110 is described.

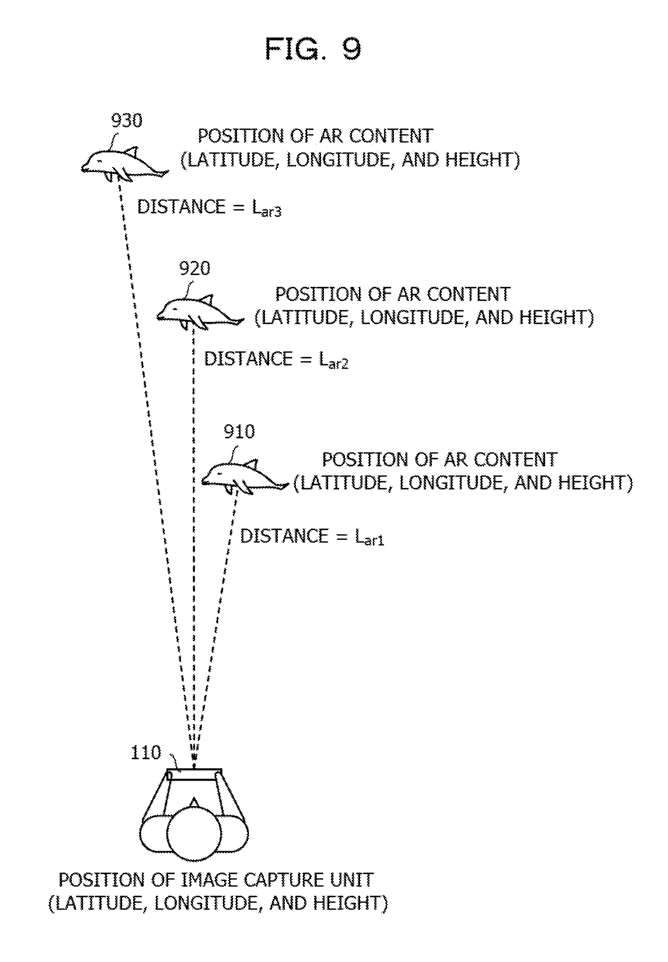

FIG. 9 is a view illustrating a positional relationship of a plurality of AR contents. As described hereinabove, the distance information indicative of distances to AR contents 910 to 930 as viewed from the image capture unit 307 of the portable terminal 110 is calculated using the expression (1) given hereinabove based on the position information associated with the AR contents 910 to 930 and the position information indicative of the position of the image capture unit 307 of the portable terminal 110.

For example, as depicted in FIG. 9, the AR content editing unit 406 calculates the distance information Lar1 from the image capture unit 307 of the portable terminal 110 to the AR content 910. Further, the AR content editing unit 406 calculates the distance information Lar2 from the image capture unit 307 of the portable terminal 110 to the AR content 920. Furthermore, the AR content editing unit 406 calculates the distance information Lar3 from the image capture unit 307 of the portable terminal 110 to the AR content 930. It is to be noted that the example of FIG. 9 indicates that the AR contents 910 to 930 include a positional relationship of Lar1<Lar2<Lar3.

<Flow of Display Controlling Process>

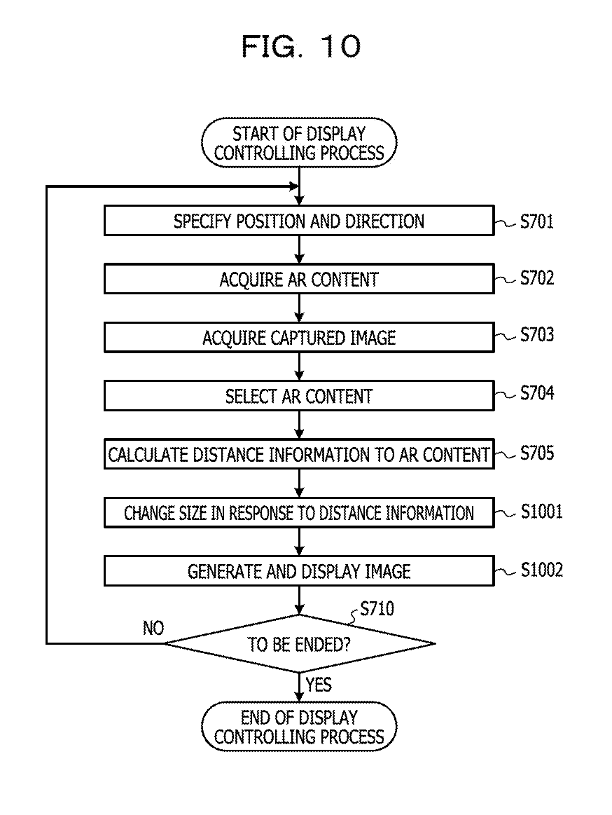

Now, a flow of the display controlling process by the display controlling unit 400 is described. FIG. 10 is a second flow chart of the display controlling process. The second flow chart of FIG. 10 is different from the first flow chart of FIG. 7 at steps S1001 and 1002.

At step S1001, the AR content editing unit 406 performs editing of changing the size of each of the AR contents 910 to 930 in accordance with the distance information (Lar1, Lar2 and Lar3) to the AR contents form the image capture unit 307.

At step S1002, the image displaying unit 407 generates an image by disposing the edited AR contents 910 to 930 whose size is changed at the corresponding display positions on the captured image and displays the generated image on the display unit 308.

<Example of Display of AR Contents>

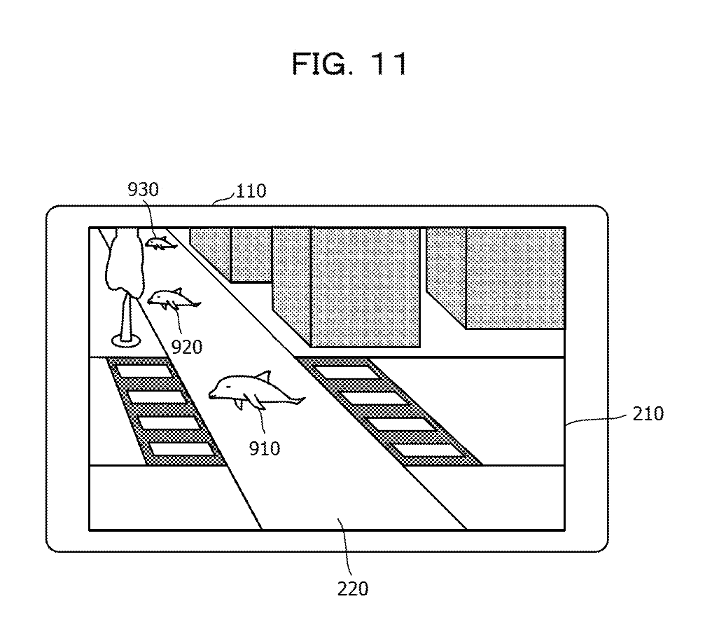

Now, an example of display of the edited AR contents 910 to 930 edited by the AR content editing unit 406 is described. FIG. 11 is a third view depicting an example of display of a captured image picked up by a portable terminal and an AR content. As depicted in FIG. 11, since the AR content 910 is smaller in distance from the image capture unit 307 than the other AR contents 920 and 930, it is displayed in a greater size on the display screen 210. Since the AR contents 920 and 930 are greater in distance from the image capture unit 307, the size thereof displayed on the display screen 210 is smaller.

As apparent from the foregoing description, the portable terminal 110 according to the second embodiment specifies an area according to a position and a direction of the image capture unit and displays AR contents associated with position information in the specified area at corresponding display positions on the captured image. Thereupon, the portable terminal 110 according to the second embodiment performs editing of changing the size of each AR content based on the distance information indicative of the distances to the AR contents as viewed from the image capture unit.

By controlling the display of an AR content on a captured image in response to distance information to the AR content, the portable terminal 110 may make it possible to easily grasp the position on the captured image according to the position information with which the AR content is associated. As a result, such a situation that, although the AR content is positioned far, it is displayed in a great size may be suppressed, and the incompatibility of the display mode may be reduced.

### Third Embodiment

In the foregoing description of the first embodiment, it is stated that the object distance acquisition unit 405 acquires distance information indicative of the distance from the image capture unit 307 in regard to all objects included in an area specified in accordance with the position and the direction of the image capture unit 307. In contrast, in a third embodiment, distance information indicative of the distance from the image capture unit 307 is acquired in regard to objects positioned around an AR content stored in an associated relationship with position information in an area specified in accordance with the position and the direction of the image capture unit 307. This is because editing of an AR content based on the positional relationship with an image pickup is needed only with regard to objects positioned around the AR content.

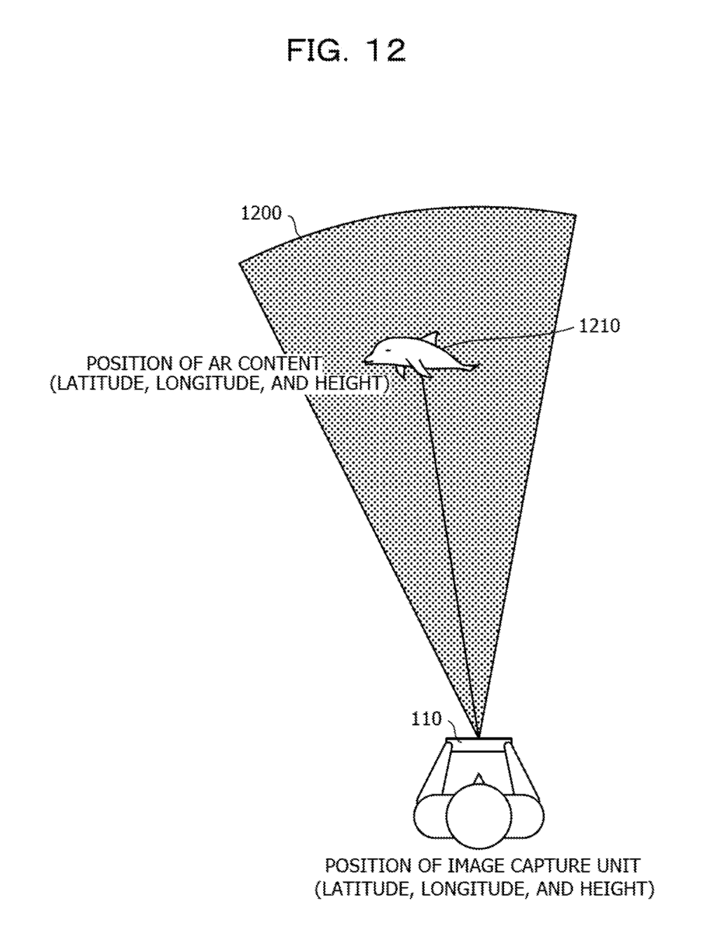

FIG. 12 is a view depicting an example of an object distance acquisition range by an object distance acquisition unit. Referring to FIG. 12, a region 1200 is a region around an AR content stored in an associated relationship with position information in an area and is an object distance acquisition range from within which the object distance acquisition unit 405 is to acquire distance information indicative of the distance from the image capture unit 307.

It is assumed that, as depicted in FIG. 12, the AR content acquisition unit 404 acquires an AR content 1210 as an AR content stored in an associated relationship with position information in an area specified according to the position and the direction of the image capture unit 307. In this case, the object distance acquisition unit 405 specifies the object distance acquisition range based on the region 1200 (region smaller than the area) in which the AR content 1210 is included, instead of based on the area. For example, the object distance acquisition unit 405 specifies the object distance acquisition range by calculating the region 1200 based on the position information associated with the AR content 1210 and the position and the direction of the image capture unit 307.

In this manner, the object distance acquisition unit 405 may reduce the processing load on the portable terminal 110 by narrowing the object distance acquisition range, from which the distance information from the image capture unit 307 is to be acquired, such that it acquires the distance information to an object in the range.

### Fourth Embodiment

In the distance measurement unit 311 in the first to third embodiments described above, the distance measurement unit 311 is disposed such that the object distance acquisition unit 405 acquires distance information to objects from the distance measurement unit 311. However, the object distance acquisition unit 405 may otherwise acquire distance information to objects, for example, from a captured image picked up by the image capture unit 307.

For example, the object distance acquisition unit 405 calculates distance information indicative of a distance to an object using the trigonometry based on the height of the image capture unit 307 upon image pickup and the display position of the object in the captured image.

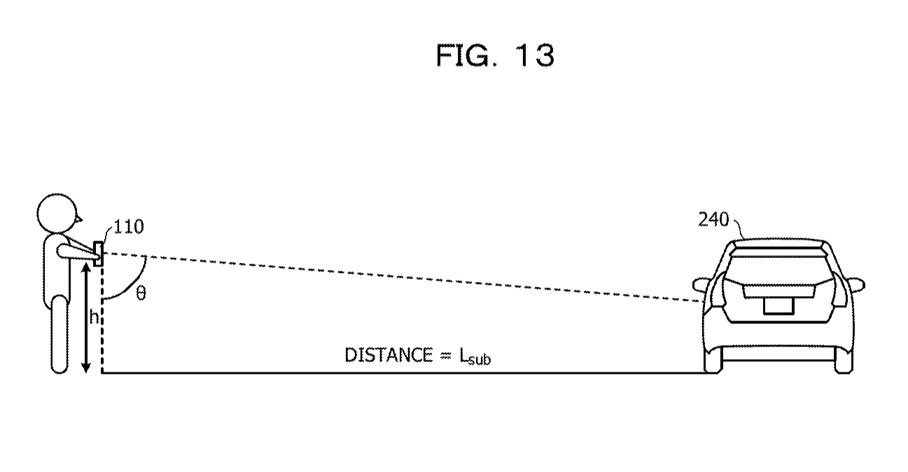

FIG. 13 is a view illustrating an example of an image pickup distance calculation process by the image pickup distance acquisition unit. As depicted in FIG. 13, by setting the height h of the image capture unit 307 and calculates a depression θ of the object 240 based on an inclination of the portable terminal 110 calculated from a result of detection of the acceleration sensor of the sensor unit 310, the distance information Lsub may be calculated by the trigonometry.

Since the object distance acquisition unit 405 calculates the distance information to an object based on a captured image in this manner, with the portable terminal 110 according to the third embodiment, the distance measurement unit 311 may not be disposed.

### Other Embodiments

In the foregoing description of the first embodiment, a case is described in which editing is performed such that a region of an AR content hidden by an object is deleted based on a positional relationship between the AR content and the object as viewed from the image capture unit. Meanwhile, in the foregoing description of the second embodiment, a case is described in which editing is performed such that the size of an AR content is changed based on distance information indicative of the distance to the AR content as viewed from the image capture unit. However, the AR content editing unit 406 may perform both of the processes. Alternatively, the AR content editing unit 406 may otherwise perform editing of changing the display mode by a method other than deletion or size change.

Further, in the foregoing description of the first, third and fourth embodiments, it is stated that, in the case where the AR content is a design and part of the design is hidden by an object, it is decided that part of the AR content is not to be displayed on the display screen 210 (editing of deleting a hidden region is performed). However, the AR content is not limited to a design, may be, for example, character data. In this case, in a situation in which part of the character data is hidden by an object, it may be decided that (not part of), the entirety of the AR content is not to be displayed. This is because, in the case of character data, even if part of them is displayed, this is often meaningless for the user.

Further, in the foregoing description of the first embodiment, a process is described in the case where it is decided that some object is positioned on the near side with respect to an AR content as viewed from the image capture unit 307 of the portable terminal 110. However, it is a matter of course that, in the case where it is decided that no object is positioned on the near side, a process for superimposing the AR content on the captured image is performed as usual. Further, in the case where it is decided that some object is positioned on the near side and the AR content is entirely hidden by an object, the AR content is not displayed. For example, it is a matter of course that, in the first embodiment, an AR content may occasionally be edited and an image to be displayed on the display screen 210 may sometimes be generated without performing editing of the AR content.

Further, in the foregoing description of the first to fourth embodiments, a case is described in which the AR content acquisition unit 404 on the real time basis acquires an AR content stored in an associated relationship with position information of an area specified in accordance with the position and the direction of the image capture unit 307. However, the timing at which the AR content acquisition unit 404 acquires an AR content is not limited to this. For example, when the display controlling unit 400 is activated, the AR content acquisition unit 404 may acquire all AR contents stored in an associated relationship with position information within a given range with reference to the position of the image capture unit 307 of the portable terminal 110 and store the AR contents into the AR content management DB 411. It is to be noted that the given range here signifies a range greater than the area specified by the position and the direction of the image capture unit 307 of the portable terminal 110. Consequently, the number of times by which the AR content acquisition unit 404 communicates with the server apparatus 120 may be reduced.

Further, while the description of the first to fourth embodiments is a description of a case in which a portable terminal is used in the AR content displaying system 100, display of an AR content may be performed using, for example, a portable terminal of the mounted type like a head-mounted display or the like. Further, in a portable terminal of the mounted type such as a head-mounted display, the display unit may be of the transmission type. It is to be noted that, in the case of a transmission type display unit, an AR content is not disposed at a corresponding display position on a captured image. The AR content is displayed directly at a corresponding position of the display unit (for example, in the case of a head-mounted display of the glasses type, a portion corresponding to the glass of the glasses).

It is to be noted that the embodiments discussed herein are not limited to the configuration described hereinabove in regard to combinations of the components and so forth described in the foregoing description of the embodiment with other elements and so forth. In this regard, the embodiments may be altered without departing from the subject pattern of the embodiments discussed therein and may be determined appropriately in response to such application forms.

All examples and conditional language recited herein of the RFID tag and the high frequency circuit are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium for storing a display controlling program, the display controlling program causing a processor to execute a process, the process comprising:
executing first processing that includes acquiring an image captured by an image capture apparatus;
executing second processing that includes specifying a position and a direction of the image capture apparatus by a sensor;
executing third processing that includes acquiring, from a storage unit configured to store a plurality of display information each of which is associated with position information, display information and position information associated with the display information, the display information being associated with position information in an area according to the specified position and direction of the image capture apparatus;
executing fourth processing that includes acquiring distance information, from among objects included in the image, to an object positioned at a display position according to the position information associated with the acquired display information;
executing fifth processing that includes deciding whether or not the acquired display information is to be displayed on a display apparatus based on the acquired distance information and position information associated with the acquired display information; and
executing sixth processing that includes displaying, in the case where it is decided that the display information is to be displayed, an image including a content based on the display information and the image on the display apparatus.

2. The non-transitory computer-readable storage medium according to claim 1, wherein
the image includes a pixel value of each of a plurality of pixels and distance information to an object corresponding to each of the plurality of pixels, and
the fourth processing is configured to acquire distance information associated with a first pixel corresponding to the display position of the display information, the first pixel being a pixel from among the pixels included in the image.

3. The non-transitory computer-readable storage medium according to claim 1, wherein
the sixth processing includes
performing a editing process that includes deleting, from the display information, a region that is positioned behind and overlaps with an object positioned at a display position according to position information associated with the display information, and
displaying an image including a content based on the edited display information and the image on the display apparatus.

4. The non-transitory computer-readable storage medium according to claim 1, wherein
the distance information calculates distance information between the specified position of the image capture apparatus and a position according to position information associated with the display information, and
the sixth processing is configured to display the display information in a form according to the distance information on a display unit.

5. The non-transitory computer-readable storage medium according to claim 4, wherein
the sixth processing includes
performing a editing process that includes changing the display information so as to have a size according to the distance information, and
displaying an image including a content based on the edited display information and the image on the display unit.

6. A display control apparatus comprising:
a memory; and
a processor coupled to the memory and configured to:
executing first processing that includes acquiring an image captured by an image capture apparatus;
executing second processing that includes specifying a position and a direction of the image capture apparatus by a sensor;
executing third processing that includes acquiring, from a storage unit configured to store a plurality of display information each of which is associated with position information, display information and position information associated with the display information, the display information being associated with position information in an area according to the specified position and direction of the image capture apparatus;
executing fourth processing that includes acquiring distance information, from among objects included in the image, to an object positioned at a display position according to the position information associated with the acquired display information;
executing fifth processing that includes deciding whether or not the acquired display information is to be displayed on a display apparatus based on the acquired distance information and position information associated with the acquired display information; and
executing sixth processing that includes displaying, in the case where it is decided that the display information is to be displayed, an image including a content based on the display information and the image on the display apparatus.

7. The display control apparatus according to claim 6, wherein
the image includes a pixel value of each of a plurality of pixels and distance information to an object corresponding to each of the plurality of pixels, and
the fourth processing is configured to acquire distance information associated with a first pixel corresponding to the display position of the display information, the first pixel being a pixel from among the pixels included in the image.

8. The display control apparatus according to claim 6, wherein
the sixth processing includes
performing a editing process that includes deleting, from the display information, a region that is positioned behind and overlaps with an object positioned at a display position according to position information associated with the display information, and
displaying an image including a content based on the edited display information and the image on the display apparatus.

9. The display control apparatus according to claim 6, wherein
the distance information calculates distance information between the specified position of the image capture apparatus and a position according to position information associated with the display information, and
the sixth processing is configured to display the display information in a form according to the distance information on a display unit.

10. The display control apparatus according to claim 9, wherein
the sixth processing includes
performing a editing process that includes changing the display information so as to have a size according to the distance information, and
displaying an image including a content based on the edited display information and the image on the display unit.

11. A display control method, performed by a computer, the method comprising:
executing first processing that includes acquiring an image captured by an image capture apparatus;
executing second processing that includes specifying a position and a direction of the image capture apparatus by a sensor;
executing third processing that includes acquiring, from a storage unit configured to store a plurality of display information each of which is associated with position information, display information and position information associated with the display information, the display information being associated with position information in an area according to the specified position and direction of the image capture apparatus;
executing fourth processing that includes acquiring distance information, from among objects included in the image, to an object positioned at a display position according to the position information associated with the acquired display information;
executing fifth processing that includes deciding whether or not the acquired display information is to be displayed on a display apparatus based on the acquired distance information and position information associated with the acquired display information; and
executing sixth processing that includes displaying, in the case where it is decided that the display information is to be displayed, an image including a content based on the display information and the image on the display apparatus.

12. The image control method according to claim 11, wherein
the image includes a pixel value of each of a plurality of pixels and distance information to an object corresponding to each of the plurality of pixels, and
the fourth processing is configured to acquire distance information associated with a first pixel corresponding to the display position of the display information, the first pixel being a pixel from among the pixels included in the image.

13. The image control method according to claim 11, wherein
the sixth processing includes
performing a editing process that includes deleting, from the display information, a region that is positioned behind and overlaps with an object positioned at a display position according to position information associated with the display information, and
displaying an image including a content based on the edited display information and the image on the display apparatus.

14. The image control method according to claim 11, wherein
the distance information calculates distance information between the specified position of the image capture apparatus and a position according to position information associated with the display information, and
the sixth processing is configured to display the display information in a form according to the distance information on a display unit.

15. The image control method according to claim 14, wherein
the sixth processing includes
performing a editing process that includes changing the display information so as to have a size according to the distance information, and
displaying an image including a content based on the edited display information and the image on the display unit.
